(19) United States
(12) Patent Application Publication
(10) Pub. No.: US 2023/0362251 A1
(43) Pub. Date: Nov. 9, 2023

(54) METHOD AND APPARATUS FOR MANAGING IOT DEVICE, AND SERVER AND STORAGE MEDIUM THEREOF

(71) Applicants: ENVISION DIGITAL INTERNATIONAL PTE.LTD., Singapore (SG); SHANGHAI ENVISION DIGITAL CO., LTD., Shanghai (CN)

(72) Inventors: Jian TANG, Shanghai (CN); Lang MING, Shanghai (CN)

(73) Assignees: ENVISION DIGITAL INTERNATIONAL PTE.LTD., Singapore (SG); SHANGHAI ENVISION DIGITAL CO., LTD., Shanghai (CN)

(21) Appl. No.: 17/774,659

(22) PCT Filed: Nov. 4, 2020
(86) PCT No.: PCT/SG2020/050636

§ 371 Date: May 5, 2022

(30) Foreign Application Priority Data
Nov. 5, 2019 (CN) 201911072652.5

(51) Int. Cl. H04L 67/12; G16Y 40/35; G16Y 30/00

(52) U.S. Cl. CPC H04L 67/12; G16Y 40/35; G16Y 30/00

(57) ABSTRACT

The present disclosure provides a method and apparatus for managing an IoT device. The method includes: acquiring device information and logic information of the IoT device, wherein the logic information is intended to indicate a logical attribute of the IoT device; generating a tree topology based on the device information and the logic information of the IoT device, wherein the tree topology comprises at least two layers of asset nodes, leaf nodes of the at least two layers of asset nodes being device asset nodes, non-leaf nodes being the device asset nodes or logical asset nodes, the device asset node corresponding to the IoT device, and the logical asset node corresponding to the logical attribute of the IoT device; and acquiring an ordered tree topology by sorting asset nodes in a same hierarchy in the tree topology.

### TECHNICAL FIELD

The present disclosure relates to the field of Internet of things (IoT), and in particular, relates to a method and apparatus for managing an IoT device, and a server and a storage medium thereof.

### BACKGROUND

With the development of the IoT technology, the number of IoT devices is increasing. A plurality of IoT devices can be connected via a bus (or a wireless network), communicate with a server, and send their own data to the server.

The server manages the IoT devices in a grouping manner. The administrator classifies a certain number of IoT devices into one group according to a preset division logic. For example, a plurality of IoT devices belonging to the same spatial location is classified into one group. As another example, a plurality of IoT devices belonging to the same function category is classified into one group.

In the related art, the IoT devices can only be divided into groups, and the management hierarchy is relatively simple. Management requirements in management scenarios where device importance and device distance are required to be reflected cannot be met.

### SUMMARY

The present disclosure provides a method and apparatus for managing an IoT device, and a server and a storage medium thereof which can be used to solve the problem that the IoT devices can only be divided into groups, the management hierarchy is relatively simple, and management requirements in management scenarios where device importance and device distance are required to be reflected cannot be met during asset management.

According to an aspect of embodiments of the present disclosure, a method for managing an IoT device is provided. The method includes:

acquiring device information and logic information of the IoT device, wherein the logic information is intended to indicate a logical attribute of the IoT device;

generating a tree topology based on the device information and the logic information of the IoT device, wherein the tree topology includes at least two layers of asset nodes, leaf nodes of the at least two layers of asset nodes being device asset nodes, non-leaf nodes being the device asset nodes or logical asset nodes, the device asset node corresponding to the IoT device, and the logical asset node corresponding to the logical attribute of the IoT device; and

acquiring an ordered tree topology by sorting asset nodes in a same hierarchy in the tree topology.

According to an aspect of embodiments of the present disclosure, a server is provided. The server includes: a memory storing at least one executable instruction therein; and a processor coupled to the memory. The at least one executable instruction, when loaded and executed by the processor, causes the processor to perform a method including:

acquiring device information and logic information of the IoT device, wherein the logic information is intended to indicate a logical attribute of the IoT device;

generating a tree topology based on the device information and the logic information of the IoT device, wherein the tree topology includes at least two layers of asset nodes, leaf nodes of the at least two layers of asset nodes being device asset nodes, non-leaf nodes being the device asset nodes or logical asset nodes, the device asset node corresponding to the IoT device, and the logical asset node corresponding to the logical attribute of the IoT device; and

acquiring an ordered tree topology by sorting asset nodes in a same hierarchy in the tree topology.

According to an aspect of embodiments of the present disclosure, a computer-readable storage medium storing at least one executable instruction therein is provided. The at least one executable instruction, when loaded and executed by the processor, causes the processor to perform a method including:

acquiring device information and logic information of the IoT device, wherein the logic information is intended to indicate a logical attribute of the IoT device;

generating a tree topology based on the device information and the logic information of the IoT device, wherein the tree topology includes at least two layers of asset nodes, leaf nodes of the at least two layers of asset nodes being device asset nodes, non-leaf nodes being the device asset nodes or logical asset nodes, the device asset node corresponding to the IoT device, and the logical asset node corresponding to the logical attribute of the IoT device; and

acquiring an ordered tree topology by sorting asset nodes in a same hierarchy in the tree topology.

According to an aspect of embodiments of the present disclosure, a computer program product storing at least one executable instruction is further provided. The at least one executable instruction, when loaded and executed by a processor, causes the processor to perform a method including:

acquiring device information and logic information of the IoT device, wherein the logic information is intended to indicate a logical attribute of the IoT device:

generating a tree topology based on the device information and the logic information of the IoT device, wherein the tree topology includes at least two layers of asset nodes, leaf nodes of the at least two layers of asset nodes being device asset nodes, non-leaf nodes being the device asset nodes or logical asset nodes, the device asset node corresponding to the IoT device, and the logical asset node corresponding to the logical attribute of the IoT device; and

acquiring an ordered tree topology by sorting asset nodes in a same hierarchy in the tree topology.

The technical solutions according to the embodiments of the present disclosure achieve at least the following beneficial effects:

By acquiring an ordered tree topology by sorting asset nodes in a same hierarchy in a tree topology, the user can be facilitated to orderly manage IoT devices corresponding to the asset nodes, and therefore, the management hierarchy is clearer and can satisfy the management needs under more management scenario.

### BRIEF DESCRIPTION OF THE DRAWINGS

The drawings herein are incorporated in and constitute a part of this specification of the present disclosure, showing embodiments consistent with the present disclosure, and explaining the principles of the present disclosure together with the description.

FIG. 1 is a block diagram of a system for managing an IoT device according to an exemplary embodiment of the present disclosure;

FIG. 2 is a flowchart of a method for managing an IoT device according to an exemplary embodiment of the present disclosure;

FIG. 3 is a schematic diagram of a method for managing an IoT device according to an exemplary embodiment of the present disclosure;

FIG. 4 is a flowchart of a method for managing an IoT device according to an exemplary embodiment of the present disclosure;

FIG. 5 is a flowchart of a method for managing an IoT device according to an exemplary embodiment of the present disclosure;

FIG. 6 is a schematic diagram of inserting a node according to an exemplary embodiment of the present disclosure;

FIG. 7 is a schematic diagram of inserting a node according to an exemplary embodiment of the present disclosure;

FIG. 8 is a flowchart of a method for managing an IoT device according to an exemplary embodiment of the present disclosure;

FIG. 9 is a schematic diagram of deleting a node according to an exemplary embodiment of the present disclosure;

FIG. 10 is a flowchart of a method for managing an IoT device according to an exemplary embodiment of the present disclosure;

FIG. 11 is a schematic diagram of moving a node according to an exemplary embodiment of the present disclosure;

FIG. 12 is a block diagram of an apparatus for managing an IoT device according to an exemplary embodiment of the present disclosure; and

FIG. 13 is a structural block diagram of a server according to an exemplary embodiment of the present disclosure.

### DETAILED DESCRIPTION

The present disclosure is described in further detail with reference to the attached drawings, to clearly present the objects, technical solutions, and advantages of the present disclosure.

The term “a plurality of” as referred to herein means two or more. The term “and/or”, describing the association relationship of the associated objects, indicates that there may be three relationships, for example, A and/or B, which may indicate that there are three cases where A exists separately, A and B exist at the same time, and B exists separately. The character “/” generally indicates that the contextual object is an “or” relationship.

Tree topology: evolved from the bus topology, which is an extension of the bus type structure. The tree topology is formed by adding branches to the bus type structure. The transmission medium of the tree topology may have multiple branches, but does not form a closed loop. The tree topology can be symmetrical and has a certain fault tolerance. When a branch fails, this branch can be separated from the entire structure. The information sent by any node can be transmitted by the transmission medium and is a broadcast network. It is a hierarchical structure, nodes are connected by hierarchy, information exchange is mainly between upper and lower nodes, and data exchange between adjacent nodes or peer nodes is generally not performed.

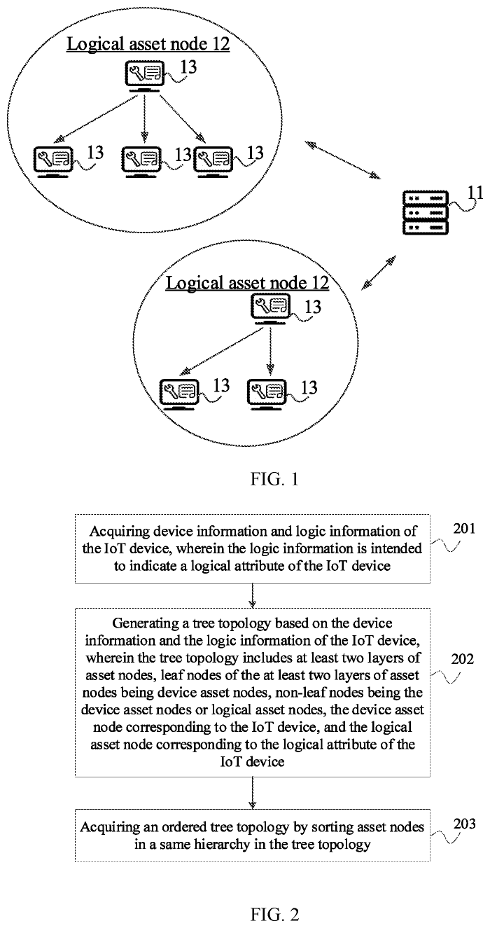

FIG. 1 shows a block diagram of a system for managing an IoT device according to an exemplary embodiment of the present disclosure, which may include a server 11, a logical asset 12, and an IoT device 13.

Exemplarily, the system for managing an IoT device includes one server 11 and one or more logical assets 12. The logical assets 12 include a plurality of IoT devices 13. The IoT devices 13 in the same logical asset 12 have the same logical attributes.

The logical attributes of the IoT device 13 include at least one of a spatial area location of the IoT device, a department to which the IoT device belongs, and a source of the IoT device.

Optionally, the server 11 and the IoT device 13 communicate with each other and are connected by a bus or a wireless network. After the server 11 establishes a connection with the IoT device 13, data information of the IoT device 13 is acquired.

The logical asset 12 corresponds to a logical asset node in a tree topology. The IoT device 13 corresponds to a device asset node in the tree topology. The device asset node as a leaf node and the logical asset node as a non-leaf node or a leaf node generate a tree topology.

Illustratively, in a system for managing an IoT energy device, the logical asset 12 is an industrial park and several factories. In the tree topology, the industrial park corresponds to a root node and is at the top of the tree topology. Logical asset nodes corresponding to several factories are child nodes of the logical asset node of the industrial park. In each factory, several IoT devices 13 are deployed, including wind energy devices, solar energy devices, natural gas devices, chemical devices, or the like. Device asset nodes corresponding to these IoT devices 13 are used as child nodes of the factory's logical asset node. The above asset node carries data information of the corresponding asset.

FIG. 2 is a flowchart of a method for managing an IoT device according to an exemplary embodiment of the present disclosure, which is applicable to a server in a system for managing an IoT device. The method includes the following steps.

In step 201, device information and logic information of the IoT device are acquired. The logic information is intended to indicate a logical attribute of the IoT device.

Optionally, the device information of the IoT device includes at least one of a type of the IoT device, a name of the IoT device, information about other IoT devices connected to the IoT device, status of the IoT device, or online time of the IoT device.

Illustratively, in a system for managing a medical IoT device, the types of these medical IoT devices are distinguished according to the departments to which they belong. The types of medical IoT devices include at least one of an inspection IoT device, a neurosurgical IoT device, a cardiac medical IoT device, an otolaryngology IoT device, an ophthalmic IoT device, or a gynecological IoT device.

The status of the IoT device includes at least one of use status and idle status.

The moment when the IoT device is switched from the idle status to the use status is defined as the online time of the IoT device and recorded in the system for managing an IoT device.

The logical information of the IoT device includes at least one of spatial area location information of the IoT device, department information of the IoT device, and source information of the IoT device.

Illustratively, the logical information is spatial area location information of the IoT device. In a factory's system for managing an IoT device, all IoT devices are classified by factory building. The IoT devices in the same factory building have the same logical attributes.

Illustratively, the logical information is department information of the IoT device. In a company's system for managing an IoT device, all IoT devices are classified by department. The IoT devices in the same department have the same logical attributes.

Illustratively, the logical information is source information of the IoT device. In a hospital's system for managing an IoT device, all IoT devices are classified by source. The sources of all IoT devices are divided into donation and self-purchasing. All IoT devices the sources of which are donation have the same logical attributes. All IoT devices the sources of which are self-purchasing have the same logical attributes.

The IoT devices are connected by a bus (or a wireless network), and send their own device information and logical information to the server.

In step 202, a tree topology is generated based on the device information and the logic information of the IoT device. The tree topology includes at least two layers of asset nodes. Leaf nodes of the at least two layers of asset nodes are device asset nodes. Non-leaf nodes are the device asset nodes or logical asset nodes. The device asset node corresponds to the IoT device. The logical asset node corresponds to the logical attribute of the IoT device.

Optionally, the tree topology is generated based on the logic information of the IoT device. The logical information of the IoT device is spatial area location information of the IoT device. A parent node of the device asset node corresponding to the IoT device is determined based on the logic information.

Exemplarily, in a factory's system for managing an IoT device, all the IoT devices are divided by spatial area location. The IoT devices in the same factory building have the same logical attributes. The device asset nodes corresponding to all IoT devices with the same logical attributes are child nodes of the logical asset node corresponding to the factory building.

Optionally, the tree topology is generated based on the device information of the IoT device. The device information of the IoT device is information about other IoT devices connected to the IoT device. Whether the device asset node corresponding to the IoT device is a child node or a parent node of device asset nodes corresponding to other IoT devices is determined based on the device information.

Exemplarily, in the above factory's system for managing an IoT device, there is a lighting switch. The server may determine that the lighting switch is connected to a plurality of lighting devices in an office based on device information of the lighting switch. Then device asset nodes corresponding to the lighting devices connected to the lighting switch are used as child nodes of a device asset node corresponding to the lighting device.

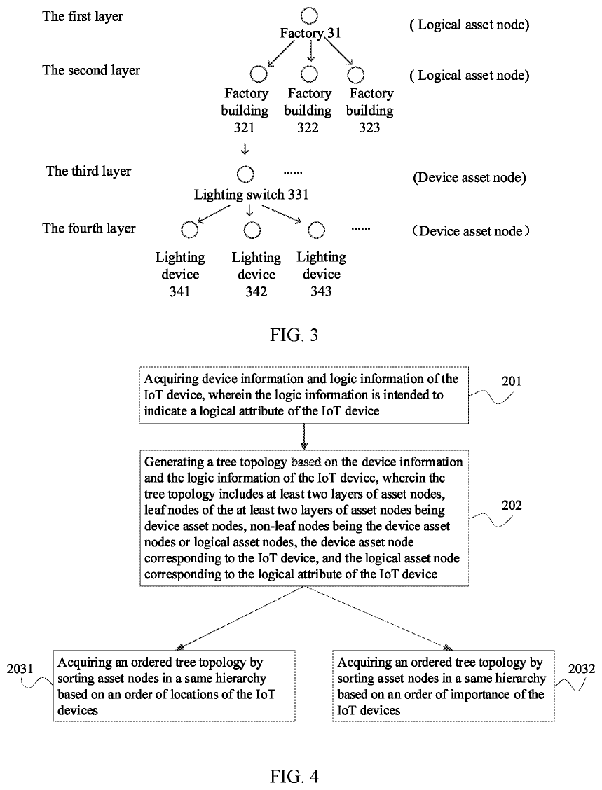

As shown in FIG. 3, all IoT devices in the factory 31 are managed. The factory 31 corresponds to a logical asset node, which is the root node of the entire tree topology and is located at the first layer of the tree topology. According to the spatial area location, the factory 31 is divided into a factory building 321, a factory building 322 and a factory building 323 corresponding to three logical asset nodes of the second layer in the tree topology.

Based on logic information of a lighting switch 331, the server may determine that the lighting switch 331 is located in the factory 321. Then a device asset node corresponding to the lighting switch 331 is used as a child node of the logical asset node corresponding to the factory 321, and is located at the third layer of the tree topology.

Based on device information of the lighting switch 331, the server may determine that a lighting device 341, a lighting device 342, and a lighting device 343 are connected to and controlled by the lighting switch 331. Then device asset nodes corresponding to the lighting device 341, the lighting device 342, and the lighting device 343 are used as child nodes of the device asset node corresponding to the lighting switch 331 and is located at the fourth layer of the tree topology.

Optionally, when the tree topology is not generated based on the logic information of the IoT device, no logical asset node exists in the tree topology, and the root node of the tree topology is a device asset node.

In step 203, an ordered tree topology is acquired by sorting asset nodes in a same hierarchy in the tree topology.

The asset nodes in the same hierarchy are logical asset nodes, or the asset nodes in the same hierarchy are device asset nodes.

It should be noted that the logical asset node and the device asset node are not in the same hierarchy.

Sorting asset nodes in the same hierarchy in the tree topology includes sorting logical asset nodes in the same hierarchy and sorting device asset nodes in the same hierarchy.

In summary, the method according to this embodiment manages IoT devices, by using a tree topology, sorts device asset nodes in the same hierarchy, thereby realizing ordered management of the IoT devices.

In an optional embodiment based on the embodiment shown in FIG. 2, FIG. 4 shows a flowchart of a method for managing an IoT device according to an exemplary embodiment of the present disclosure, which is applicable to a server in a system for managing an IoT device. In this embodiment, step 203 in the foregoing embodiment may be replaced by step 2031 or step 2032. The method includes the following steps.

In step 2031, the ordered tree topology is acquired by sorting the asset nodes in the same hierarchy based on an order of locations of the IoT devices.

In an example, acquiring the ordered tree topology by sorting the asset nodes in the same hierarchy based on the order of locations of the IoT devices includes: receiving coordinate data of the IoT device; calculating a distance between the IoT device and a reference point based on the coordinate data of the IoT device; and acquiring the ordered tree topology by sorting the asset nodes in the same hierarchy based on the distance between the IoT device and the reference point.

Optionally, the coordinate data of the IoT device is determined by a satellite locating system. The server receives the coordinate data of the IoT device by establishing a connection with the satellite locating system.

The reference point is set by the administrator and may be located at any location.

Illustratively, the administrator setting the reference point is an IoT device a at the center of all the IoT devices of the layer, and distances of other IoT devices of the layer to the IoT device a are calculated. A sequence number value of the IoT device a is 1, and the closer an IoT device to the IoT device a, the smaller the sequence number value of the IoT device. By the sequence number, the administrator may directly determine which IoT devices in the same hierarchy are located in an edge region, and which IoT devices are located in a central region. In summary, the method according to this embodiment can meet the management requirements of the administrator by sorting IoT devices in the same hierarchy based on an order of locations of the IoT devices when the device distance needs to be reflected.

In step 2032, the ordered tree topology is acquired by sorting the asset nodes in the same hierarchy based on an order of importance of the IoT devices.

In an example, acquiring the ordered tree topology by sorting the asset nodes in the same hierarchy based on the order of importance of the IoT devices includes: receiving an importance set instruction; setting the importance of the IoT device based on the importance set instruction; and acquiring the ordered tree topology by sorting the asset nodes in the same hierarchy based on the importance of the IoT devices.

Optionally, the importance set instruction is customized by the administrator.

Optionally, the higher the degree of importance, the smaller the sequence number value of the IoT device. Among IoT devices in the same hierarchy, the IoT device with the lowest sequence number is the most important to the IoT system.

Illustratively, an IoT device in a laboratory is managed. The administrator sets the importance based on the frequency of use of all IoT devices, and the higher the frequency of use, the higher the importance. Among IoT devices in the same hierarchy, the administrator may directly determine the frequency of use of the IoT device based on the order of these IoT devices.

In summary, the method provided according to this embodiment can meet the management requirements of the administrator in a management scenario that needs to reflect device importance by sorting the IoT devices in the same hierarchy based on the order of importance of the IoT devices.

The management of the IoT device includes at least one of adding an IoT device, deleting an IoT device, and moving an IoT device.

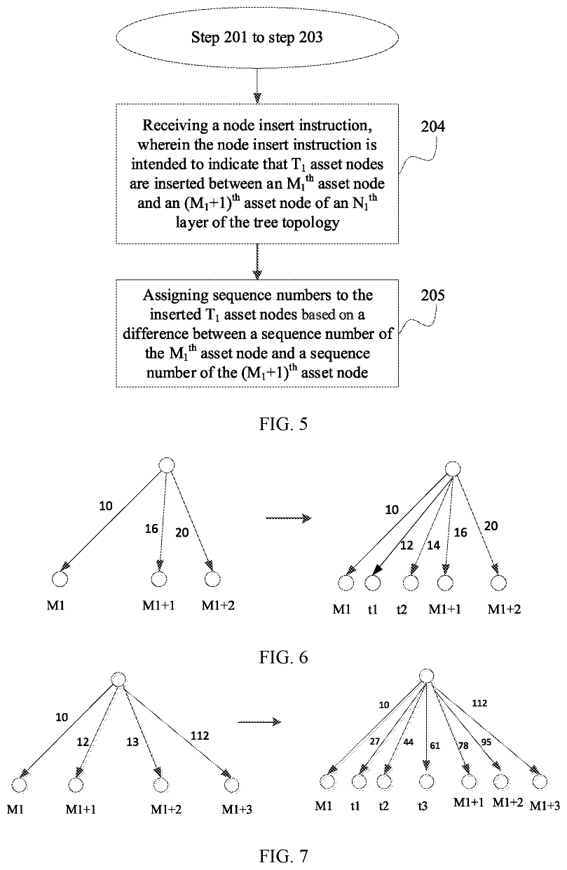

When the IoT device is managed by using a tree topology, adding an IoT device corresponds to inserting an asset node at a certain layer of the tree topology. FIG. 5 below shows a flowchart of inserting an asset node. FIG. 6 shows an example of inserting an asset node.

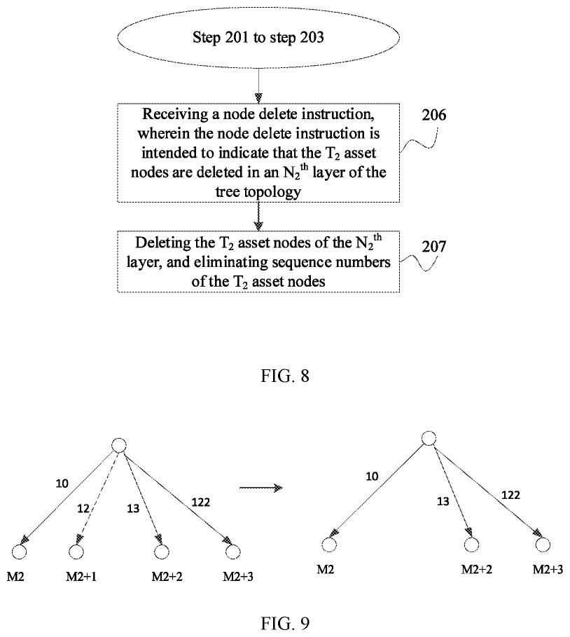

Deleting an IoT device corresponds to deleting an asset node at a certain layer of the tree topology. FIG. 7 below shows a flowchart of deleting an asset node. FIG. 8 shows an example of deleting an asset node.

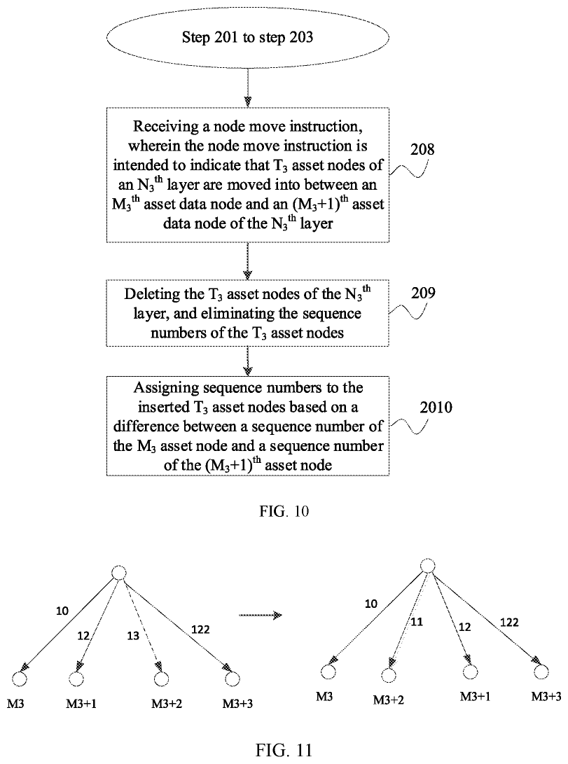

Moving an IoT device corresponds to moving an asset node at a certain layer of the tree topology. FIG. 9 below shows a flowchart of moving an asset node. FIG. 10 shows an example of moving an asset node.

FIG. 5 is a flowchart of a method for managing an IoT device according to an exemplary embodiment of the present disclosure, which is applicable to a server in a system for managing an IoT device. In this embodiment, after step 203 in the embodiment shown in FIG. 2, the following steps are also performed:

In step 204, a node insert instruction is received. The node insert instruction is intended to indicate that T₁ asset nodes are inserted between an M₁^{th} asset node and an (M₁+1)^{th} asset node of an N₁^{th} layer of the tree topology.

It is assumed that the tree topology has a total of N layers, and the value of N₁ ranges from 1 to N.

It is assumed that the N₁^{th} layer of the tree topology has a total of M asset nodes, and the value of M₁ ranges from 1 to M−1.

T1 is an arbitrary integer greater than zero.

The node insert instruction is triggered by the administrator. When it is necessary to add a new IoT device in the system for managing an IoT device, the administrator locates a device asset node corresponding to the newly added IoT device in the N₁^{th} layer of the tree topology based on the logical attribute of the newly added IoT device. The insertion location at the N₁^{th} layer is selected by the administrator.

Illustratively, in a system for managing a medical IoT device, a newly added electrocardiograph needs to be managed, and the electrocardiograph belongs to a medical IoT device of the cardiology department. In the tree topology, the cardiology department corresponds to a logical asset node and located at an (N₁−1)^{th} layer of the tree topology. Then a device asset node corresponding to the newly added electrocardiograph is used as a child node of the logical asset node of the cardiology department and inserted in the N₁^{th} layer of the tree topology.

In step 205, sequence numbers are assigned to the inserted T₁ asset nodes based on a difference between a sequence number of the M₁^{th} asset node and a sequence number of the (M₁+1)^{th} asset node.

The difference between the sequence number of the M₁^{th} asset node and the sequence number of an (M₁+1)^{th} asset node is calculated by the following formula 1:

W_{SS}=V_{M1+i}−V_{M1} Formula one:

where WSS is the difference between the sequence number of the M₁^{th} asset node and the sequence number of an (M₁+1)^{th} asset node, V_{M1+i} is a sequence number value of the (M₁+1)^{th} asset node, and V_{M}i is a sequence number value of the M₁^{th} asset node.

The interval of the sequence number values of the inserted T₁ asset nodes is as shown in the following formula 2:

A′=[(V_{M1+i}−V_{M1})(T1+i)] Formula 2:

where A′ is the interval of the sequence number values of the inserted T₁ asset nodes, and A′ is an integer, which is obtained by rounding.

In an example, when the difference between the sequence number of the M₁^{th} asset node and the sequence number of the (M₁+1)^{th} asset node is greater than T₁, sequence numbers are assigned to the inserted T₁ asset nodes by using sequence numbers between the sequence number of the M₁^{th} asset node and the sequence number of the (M₁+1)^{th} asset node.

Calculation is performed by the value of i taking 1 in the above Formulas 1 and 2.

As shown in FIG. 6, the value of T₁ is 2, and two asset nodes t1 and t2 are inserted between the M₁^{th} asset node and the (M₁+1)^{th} asset node.

The value of i is 1, and the difference between the sequence number of the M₁^{th} asset node and the sequence number of the (M₁+1)^{th} asset node is calculated by using Formula 1, W_{SS}=V_{M1+1}V_{M1}=16−10=6. The value of Wss is 6, which is greater than the value 2 of T₁.

Sequence numbers are assigned to the inserted T₁ asset nodes by using sequence numbers between the sequence number of the M₁^{th} asset node and the sequence number of the (M₁+1)^{th} asset node. The interval of the sequence number values of the inserted two asset nodes is calculated using Formula 2. A′=[(V_{M1+1}−V_{M1})/(T1+1)]=[6/3]=2. A sequence number of the asset node t1 is assigned as Vₜ₁=10+1*2=12, and a sequence number of the asset node t2 is assigned as Vₜ₂=10+2*2=14.

In an example, when the difference between the sequence number of the M₁^{th} asset node and the sequence number of the (M₁+1)^{th} asset node is less than T₁, a difference between the sequence number of the M₁^{th} asset node and a sequence number of the (M₁+1)^{th} asset node is calculated until the difference between the sequence number of the M₁^{th} asset node and the sequence number of the (M₁+1)^{th} asset node is greater than T₁+i−1; the T₁ asset nodes are inserted between the M₁^{th} asset node and the (M₁+1)^{th} asset node; and the sequence numbers of the (M₁+1)^{th} asset node to an (M₁+i−1)^{th} asset node are adjusted by using the sequence numbers between the sequence number of the M₁^{th} asset node and the sequence number of the (M₁+1)^{th} asset node, and sequence numbers are assigned to the inserted T₁ asset nodes.

As shown in FIG. 7, the value of T₁ is 3, and three asset nodes t1, t2, and t3 are inserted between the M₁^{th} asset node and the (M₁+1)^{th} asset node.

The value of i is 1, and the difference between the sequence number of the M₁^{th} asset node and the sequence number of the (M₁+1)^{th} asset node is calculated by using Formula 1, W_{SS}=V_{M1+1}−V_{M1}=12−10=2. The value of Wss is 2, which is less than the value 3 of T₁.

The value of i is 2, and a difference between the sequence number of the M₁^{th} asset node and a sequence number of an (M₁+2)^{th} asset node is calculated by using Formula 1, W_{SS}=V_{M1+2}−V_{M1}=13−10=3. The value of Wss is 3, which is less than T₁+i−1. The value is 4.

The value of i is 3, and a difference between the sequence number of the M₁^{th} asset node and a sequence number of an (M₁+3)^{th} asset node is calculated by using Formula 1, W_{SS}=V_{M1+2}−V_{M1}=112−10=102. The value of Wss is 102, which is greater than the value 5 of T₁+i−1.

The sequence numbers of the (M₁+1)^{th} asset node to the (M₁+i−1)^{th} asset node are adjusted by using the sequence numbers between the sequence number of the M₁^{th} asset node and the sequence number of the (M₁+3)^{th} asset node, and the inserted T₁ asset nodes are assigned sequence numbers. The interval of the sequence number values of the inserted three asset nodes are calculated by using Formula 2.

A sequence number of the asset node t1 is assigned as Vₜ₁=10+1*17=27. A sequence number of the asset node t2 is assigned as Vₜ₂=10+2*17=44. A sequence number of the asset node t3 is assigned as Vₜ₃=10+3*17=61. The sequence number of the (M₁+1)^{th} asset node is adjusted to V_{M1+1}=10+4*17=78. The sequence number of the (M₁+2)^{th} asset node is adjusted to V_{M1+1}=10+5*17=95.

It should be noted that the M₁^{th} asset node and the (M₁+1)^{th} asset node in the foregoing embodiment both exist, and inserting T₁ asset nodes between the M₁^{th} asset node and the (M₁+1)^{th} asset node at the N₁^{th} layer of the tree topology structure also includes the following situations.

1. The M₁^{th} asset node does not exist, the (M₁+1)^{th} asset node exists, and T₁ asset nodes from a t1^{th} asset node to a ti^{th} asset node are inserted.

The sequence numbers of the inserted T₁ asset nodes are Vti=V_{M1+1}−ti*A, (ti=1, 2, 3 . . . ), where A is a fixed value, and the sequence number difference of the inserted adjacent asset nodes is A.

2. The M₁^{th} asset node exists, the (M₁+1)^{th} asset node does not exist, and T₁ asset nodes from the t1^{th} asset node to the ti^{th} asset node are inserted.

The sequence number of the inserted T₁ asset nodes is Vₜᵢ=V_{M1+1}+ti*A, (ti=1, 2, 3 . . . ), where A is a fixed value, and the sequence number difference of the inserted adjacent asset nodes is A.

3. The M₁^{th} asset node does not exist, the (M₁+1)^{th} asset node does not exist, and T1 asset nodes from the t1^{th} asset node to the ti^{th} asset node are inserted.

The sequence numbers of the inserted T₁ asset nodes are Vₜᵢ=MIN_VALUE+ti*A, (ti=1, 2, 3 . . . ), where A is a fixed value, and the sequence number difference of the inserted adjacent asset nodes is A. MIN_VALUE is a fixed value and the user sets the value of MIN_VALUE by the server.

In summary, the method provided in this embodiment can quickly insert a device asset node corresponding to a newly added IoT device when more IoT devices need to be managed by receiving a node insert instruction and inserting several asset nodes at specified locations, and at the same time does not affect the ordering of the IoT devices managed at this layer.

FIG. 8 is a flowchart of a method for managing an IoT device according to an exemplary embodiment of the present disclosure, which is applicable to a server in a system for managing an IoT device. In this embodiment, after step 203 in the embodiment shown in FIG. 2, the following steps are also performed.

In step 206, a node delete instruction is received. The node delete instruction is intended to indicate that the T₂ asset nodes are deleted in the N2^{th} layer of the tree topology.

It is assumed that the tree topology has a total of N layers, and the value of N₂ ranges from 1 to N. T₂ is any integer greater than zero.

The node delete instruction is triggered by the administrator.

In step 207, the T₂ asset nodes of the N2^{th} layer are deleted, and sequence numbers of the T₂ asset nodes are eliminated.

It should be noted that the T₂ asset nodes that are deleted may have other asset nodes mounted, and the mounted asset nodes are also deleted.

It should be noted that deleting the T2 asset nodes of the N2^{th} layer does not affect the sequence number values of other undeleted asset nodes of the layer.

As shown in FIG. 9, the value of T₂ is 1, an (M₂+1)^{th} asset node of the layer is deleted, and the sequence number 12 of the (M₂+1)^{th} asset is eliminated.

It should be noted that the sequence number of the M₂^{th} asset node is still 10, the sequence number of an (M₂+2)^{th} asset node is still 13, and the sequence number of the (M₂+2)^{th} asset node is still 122, which will not change due to the deletion of the (M₂+1)^{th} asset node.

In summary, the method provided in this embodiment receives a node delete instruction and deletes an asset node at a specified location when it is not required to manage an IoT device, and does not affect the ordering of other asset nodes at this layer at the same time.

FIG. 10 is a flowchart of a method for managing an IoT device according to an exemplary embodiment of the present disclosure, which is applicable to a server in a system for managing an IoT device. In this embodiment, after step 203 in the embodiment shown in FIG. 2, the following steps are also performed.

In step 208, a node move instruction is received. The node move instruction is intended to indicate that T₃ asset nodes of an N₃^{th} layer are moved into between an M₃^{th} asset data node and an (M₃+1)^{th} asset data node of the N₃^{th} layer.

It is assumed that the tree topology has a total of N layers, and the value of N₃ ranges from 1 to N.

It is assumed that the N₃^{th} layer of the tree topology has a total of M asset nodes, and the value of M₃ ranges from 1 to M−1.

T3 is any integer greater than zero.

The node move instruction is triggered by the administrator. When it is necessary to move some IoT devices in the system for managing an IoT device, the administrator moves device asset nodes corresponding to the newly added IoT devices to the N₁^{th} layer of the tree topology based on the logical attributes of the newly added IoT devices, and the insertion locations at the N₁^{th} layer are selected by the administrator.

Illustratively, in a system for managing a medical IoT device, a surgical microscope of a neurosurgery department needs to be moved to a shaping department for management. In the tree topology, the shaping department corresponds to a logical asset node and located at the (N₁−1)^{th} layer of the tree topology. Then a device asset node corresponding to the surgical microscope to be moved is used as a child node of the logical asset node of the shaping department and inserted at the N₁^{th} layer of the tree topology.

In step 209, the T₃ asset nodes of the N₃^{th} layer are deleted, and the sequence numbers of the T₃ asset nodes are eliminated.

It should be noted that deleting the T₃ asset nodes of the N₃^{th} layer does not affect the sequence number values of other undeleted asset nodes of the layer.

In step 2010, sequence numbers are assigned to the inserted T₃ asset nodes based on a difference between a sequence number of the M₃ asset node and a sequence number of the (M₃+1)^{th} asset ode.

Optionally, when the difference between the sequence number of the M₃^{th} asset node and the sequence number of the (M₃+1)^{th} asset node is greater than T₃, the sequence numbers between the sequence number of the M₃^{th} asset node and the sequence number of the (M₃+1)^{th} asset node are assigned to the inserted T₃ asset nodes.

Optionally, when the difference between the sequence number of the M3^{th} asset node and the sequence number of the (M₃+1)^{th} asset node is less than T₃, a difference between the sequence number of the M₃^{th} asset node and a sequence number of an (M₃+i)^{th} asset node is calculated until the difference between the sequence number of the M₃^{th} asset node and the sequence number of the (M₃+i)^{th} asset node is greater than T3+i−1; T₃ asset nodes are inserted between the M₃^{th} asset node and the (M₃+i)^{th} asset node; and the sequence numbers of the (M₃+1)^{th} asset node to an (M₃+i−1)^{th} asset node are adjusted by using the sequence numbers between the sequence number of the M₃^{th} asset node and the sequence number of the (M₃+i)^{th} asset node and sequence numbers are assigned to the inserted T₃ asset nodes.

As shown in FIG. 11, the value of T₃ is 1, and an (M₃+2)^{th} asset node of an N₃^{th} layer is moved into between the M₃^{th} asset data node and the (M₃+1)^{th} asset data node of the N₃^{th} layer.

The (M₃+2)^{th} asset node of the layer is deleted, and the sequence number 13 of the (M₃+2)^{th} asset is eliminated.

The difference between the sequence number of the M₃^{th} asset node and the sequence number of the (M₃+1)^{th} asset node is calculated, W_{SS}=V_{M3+1}−V_{M3}=12−10=2. The value of Wss is 2, which is greater than the value 1 of T₁.

The sequence numbers between the sequence number of the M₃^{th} asset node and the sequence number of the (M₃+1)^{th} asset node are assigned to the inserted one asset node. The interval of the sequence number value of the inserted one asset node is calculated,

A′=[(V_{M3+1}−V_{M1})/(T3+1)]=[(12−10)/2]=1. The sequence number of the (M3+2)^{th} asset node is reassigned as V_{M3+2}=10+1*1=11.

In summary, in the method provided in this embodiment, when it is required to move the location of a certain asset node in a tree topology, the asset node is first deleted by receiving a node move instruction, and then the asset node is inserted into a specified location without affecting the ordering of other asset nodes in the same layer.

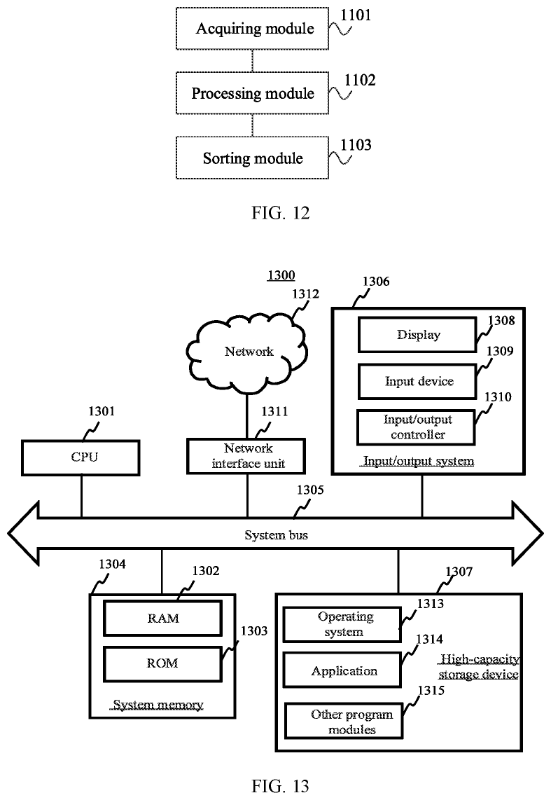

FIG. 12 is a block diagram of an IoT device management apparatus according to an exemplary embodiment of the present disclosure. The apparatus includes an acquiring module 1101, a processing module 1102, and a sorting module 1103.

The acquiring module 1101 is configured to acquire device information and logic information of the IoT device, where the logic information is intended to indicate a logical attribute of the IoT device.

The processing module 1102 is configured to generate a tree topology based on the device information and the logic information of the IoT device, wherein the tree topology includes at least two layers of asset nodes. Leaf nodes of the at least two layers of asset nodes are device asset nodes, non-leaf nodes are device asset nodes or logical asset nodes, the device asset node correspond to an IoT device, and the logical asset node correspond to the logical attribute of the IoT device.

The sorting module 1103 is configured to acquire an ordered tree topology by sorting asset nodes in a same hierarchy in the tree topology.

In an embodiment, the sorting module 1103 is configured to acquire the ordered tree topology by sorting the asset nodes in the same hierarchy based on an order of locations of the IoT devices; or, the sorting module 1103 is configured to acquire the ordered tree topology by sorting the asset nodes in the same hierarchy based on an order of importance of the IoT devices.

In an embodiment, the acquiring module 1101 is configured to receive coordinate data of the IoT device. The processing module 1102 is configured to calculate a distance between the IoT device and a reference point based on the coordinate data of the IoT device. The sorting module 1103 is configured to acquire the ordered tree topology by sorting the asset nodes in the same hierarchy based on the distance between the IoT device and the reference point.

In an embodiment, the acquiring module 1101 is configured to receive an importance set instruction. The processing module 1102 is configured to set an importance of the IoT device based on the importance set instruction. The sorting module 1103 is configured to acquire the ordered tree topology by sorting the asset nodes in the same hierarchy based on the importance of the IoT device.

In an embodiment, a sequence number difference between adjacent asset nodes is a fixed value A, and A is an integer greater than 1. The acquiring module 1101 is configured to receive a node insert instruction. The node insert instruction is intended to indicate that T₁ asset nodes are inserted between an M₁^{th} asset node and an (M₁+1)^{th} asset node of an N₁^{th} layer of the tree topology. The sorting module 1103 is configured to assign sequence numbers to the inserted T₁ asset nodes based on a difference between a sequence number of the M₁^{th} asset node and a sequence number of the (M₁+1)^{th} asset the node.

In an embodiment, the sorting module 1103 is configured to assign the sequence numbers between the sequence number of the (M₁+1)^{th} asset node and the sequence number of the M₁^{th} asset node to the inserted T₁ asset nodes when the difference between the sequence number of the M₁^{th} asset node and the sequence number of the (M₁+1)^{th} asset node is greater than T₁.

In an embodiment, the sorting module 1103 is configured to, when the difference between the sequence number of the M₁^{th} asset node and the sequence number of the (M₁+1)^{th} asset node is less than T₁, calculate a difference between the sequence number of the M₁^{th} asset node and a sequence number of an (M₁+1)^{th} asset node until the difference between the sequence number of the M₁^{th} asset node and the sequence number of the (M₁+1)^{th} asset node is greater than T₁+i−1.

The sorting module 1103 is configured to insert the T₁ asset nodes between the M₁^{th} asset node and the (M₁+1)^{th} asset node.

The sorting module 1103 is configured to adjust the sequence numbers of the (M₁+1)^{th} asset node to an (M₁+i−1)^{th} asset node by using the sequence numbers between the sequence number of the M₁^{th} asset node and the sequence number of the (M₁+1)^{th} asset node and assign sequence numbers to the inserted T₁ asset node.

where i is an integer greater than one.

In an embodiment, a sequence number difference between adjacent asset nodes is a fixed value A, and A is an integer greater than 1. The acquiring module 1101 is configured to receive a node delete instruction. The node delete instruction is intended to indicate that T₂ asset nodes of an N₂^{th} layer of the tree topology are deleted. The sorting module 1103 is configured to delete the T₂ asset nodes of the N2^{th} layer, and eliminate the sequence numbers of the T₂ asset nodes.

In an embodiment, a sequence number difference between adjacent asset nodes is a fixed value A, and A is an integer greater than 1. The acquiring module 1101 is configured to receive a node move instruction. The node move instruction is intended to indicate that T₃ asset nodes of an N₃^{th} layer are moved into between an M₃₁ asset data node and an (M₃+1)^{th} asset data node of the N₃^{th} layer. The sorting module 1103 is configured to delete the T₃ asset nodes of the N₃^{th} layer, and eliminate the sequence numbers of the T₃ asset nodes. The sorting module 1103 is configured to assign sequence numbers to the inserted T₃ asset nodes based on the difference between the sequence number of the M₃ asset node and the sequence number of the (M₃+1)^{th} asset node.

The present disclosure further provides a server including a processor and a memory storing at least one instruction therein. The at least one instruction, when loaded and executed by the processor, causes the processor to perform the security detection method according to the above method embodiments. It should be noted that the server may be the server as illustrated in FIG. 13.

FIG. 13 is a schematic diagram of a server according to an embodiment of the present disclosure. Specifically, the server 1300 includes a central processing unit (CPU) 1301, a system memory 1304 including a random access memory (RAM) 1302 and a read-only memory (ROM) 1303, and a system bus 1305 connecting the system memory 1304 and the central processing unit 1301. The server 1300 further includes a basic input/output system (I/O system) 1306 which helps transmit information between various components within the server, and a high-capacity storage device 1307 for storing an operating system 13013, an application 1014 and other program modules 1015.

The basic input/output system 1306 includes a display 1308 for displaying information and an input device 1309, such as a mouse and a keyboard, for inputting information by the user. Both the display 1308 and the input device 1309 are connected to the central processing unit 1301 by an input/output controller 1310 connected to the system bus 1305. The basic input/output system 1306 may also include the input/output controller 1310 for receiving and processing input from a plurality of other devices, such as the keyboard, the mouse, or an electronic stylus. Similarly, the input/output controller 1310 further provides output to the display, a printer, or other types of output devices.

The high-capacity storage device 1307 is connected to the central processing unit 1301 by a high-capacity storage controller (not shown) connected to the system bus 1305. The high-capacity storage device 1307 and a server-readable medium associated therewith provide non-volatile storage for the server 1300. That is, the high-capacity storage device 1307 may include the server-readable medium (not shown), such as a hard disk or a CD-ROM driver.

Without loss of generality, the server-readable medium may include a server storage medium and a communication medium. The server storage medium includes volatile and non-volatile, and removable and non-removable media implemented in any method or technology for storage of information such as a server-readable instruction, a data structure, a program module, or other data. The server storage medium includes a RAM, a ROM, an EPROM, an EEPROM, a flash memory, or other solid-state storage technologies; a CD-ROM, DVD, or other optical storage; and a tape cartridge, a magnetic tape, a disk storage, or other magnetic storage devices. It is known by a person skilled in the art that the server storage medium is not limited to above. The above system memory 1304 and the high-capacity storage device 1307 may be collectively referred to as the memory.

The memory stores one or more programs. The one or more programs are configured to be executed by the one or more CPUs 1301. The one or more programs include instructions for performing the methods for managing the IoT device as described above. The CPU 1301 runs the one or more programs to perform the methods for managing the IoT device according to the above method embodiments.

According to the various embodiments of the present disclosure, the server 1300 may also be run by a remote server connected to a network via a network, such as the Internet. That is, the server 1300 may be connected to the network 1312 by a network interface unit 1311 connected to the system bus 1305, or may be connected to other types of networks or remote server systems (not shown) with the network interface unit 1311.

The memory further includes one or more programs stored therein. The one or more programs include the steps performed by the database server in the methods for managing the IoT device according to the embodiments of the present disclosure.

An embodiment of the present disclosure further provides a computer-readable storage medium storing at least one instruction therein. The at least one instruction, when loaded and executed by the processor, causes the processor to perform the methods for managing the IoT device according to the above embodiments.

An embodiment of the present disclosure further provides a computer program product storing at least one instruction. The at least one instruction, when loaded and executed by the processor, causes the processor to perform the methods for managing the IoT device according to the above embodiments.

A person skilled in the art shall appreciate that in one or more examples described above, the functions described in the embodiments of the present disclosure may be implemented in hardware, software, firmware, or any combination thereof. If the functions are implemented in the software, they may be stored in a computer-readable medium or transmitted as one or more instructions or codes on a computer-readable medium. The computer-readable medium includes a computer storage medium and a communication medium, wherein the communication medium includes any medium that facilitates transfer of a computer program from one place to another, and the storage medium may be any available medium that can be accessed by a general-purpose or special-purpose computer.

Described above are only the exemplary embodiments of the present disclosure, which are not intended to limit the present disclosure. Various changes and modifications may be made to the present disclosure for those skilled in the art. Any modifications, equivalent substitutions, improvements, and the like made within the spirit and principles of the present disclosure should be included within the scope of the present disclosure.

What is claimed is:

1. A method for managing an Internet of Things (IoT) device, comprising:
acquiring device information and logic information of the IoT device, wherein the logic information is intended to indicate a logical attribute of the IoT device;
generating a tree topology based on the device information and the logic information of the IoT device, wherein the tree topology comprises at least two layers of asset nodes, leaf nodes of the at least two layers of asset nodes being device asset nodes, non-leaf nodes being the device asset nodes or logical asset nodes, the device asset node corresponding to the IoT device, and the logical asset node corresponding to the logical attribute of the IoT device; and
acquiring an ordered tree topology by sorting asset nodes in a same hierarchy in the tree topology.

2. The method according to claim 1, wherein acquiring the ordered tree topology by sorting the asset nodes in the same hierarchy in the tree topology comprises:
acquiring the ordered tree topology by sorting the asset nodes in the same hierarchy based on an order of locations of the IoT devices; or
acquiring the ordered tree topology by sorting the asset nodes in the same hierarchy based on an order of importance of the IoT devices.

3. The method according to claim 1, wherein a sequence number difference between adjacent asset nodes is a fixed value A, A being an integer greater than one; and
the method further comprises:
receiving a node insert instruction, wherein the node insert instruction is intended to indicate that T₁ asset nodes are inserted between an M₁^{th} asset node and an (M₁+1)^{th} asset node of an N₁^{th} layer of the tree topology, and
assigning sequence numbers to the inserted T₁ asset nodes based on a difference between a sequence number of the M₁^{th} asset node and a sequence number of the (M₁+1)^{th} asset node.

4. The method according to claim 3, wherein assigning the sequence numbers to the inserted T₁ asset nodes based on the difference between the sequence number of the M₁^{th} asset node and the sequence number of the (M₁+1)^{th} asset node comprises:
when the difference between the sequence number of the M₁^{th} asset node and the sequence number of the (M₁+1)^{th} asset node is greater than T₁, assigning sequence numbers to the inserted T₁ asset nodes by using sequence numbers between the sequence number of the M₁^{th} asset node and the sequence number of the (M₁+1)^{th} asset ode.

5. The method according to claim 4, wherein assigning the sequence numbers to the inserted T₁ asset nodes based on the difference between the sequence number of the M₁^{th} asset node and the sequence number of the (M₁+1)^{th} asset node comprises:
when the difference between the sequence number of the M₁^{th} asset node and the sequence number of the (M1+1)^{th} asset node is less than T₁, calculating a difference between the sequence number of the M₁^{th} asset node and a sequence number of an (M₁+1)^{th} asset node until the difference between the sequence number of the M₁^{th} asset node and the sequence number of the (M₁+i)^{th} asset node is greater than T₁+i−1;
inserting the T₁ asset nodes between the M₁^{th} asset node and the (M₁+1)^{th} asset node; and
adjusting the sequence numbers of the (M₁+1)^{th} asset node to an (M₁+i−1)^{th} asset node by using sequence numbers between the sequence number of the M₁^{th} asset node and the sequence number of the (M₁+i)^{th} asset node and assigning sequence numbers to the inserted T₁ asset nodes;
where i is an integer greater than one.

6. The method according to claim 1, wherein a sequence number difference between adjacent asset nodes is a fixed value A, A being an integer greater than one; and
the method further comprises:
receiving a node delete instruction, wherein the node delete instruction is intended to indicate that T₂ asset nodes are deleted from an N₂^{th} layer of the tree topology; and
deleting the T₂ asset nodes of the N₂^{th} layer, and eliminating sequence numbers of the T₂ asset nodes.

7. The method according to claim 1, wherein a sequence number difference between adjacent asset nodes is a fixed value A, A being an integer greater than one; and
the method further comprises:
receiving a node move instruction, wherein the node move instruction is intended to indicate that T₃ asset nodes of an N3^{th} layer are moved into between an M₃^{th} asset data node and an (M3+₁)^{th} asset data node of the N₃^{th} layer;
deleting the T₃ asset nodes of the N3^{th} layer, and eliminating sequence numbers of the T₃ asset nodes; and
assigning sequence numbers to the inserted T₃ asset nodes based on a difference between a sequence number of the M₃^{th} asset node and a sequence number of the (M₃+1)^{th} asset node.

8. A server, comprising:
a memory storing at least one executable instruction therein; and
a processor coupled to the memory:
wherein the at least one executable instruction, when loaded and executed by the processor, causes the processor to perform a method comprising:
acquiring device information and logic information of the IoT device, wherein the logic information is intended to indicate a logical attribute of the IoT device;
generating a tree topology based on the device information and the logic information of the IoT device, wherein the tree topology comprises at least two layers of asset nodes, leaf nodes of the at least two layers of asset nodes being device asset nodes, non-leaf nodes being the device asset nodes or logical asset nodes, the device asset node corresponding to the IoT device, and the logical asset node corresponding to the logical attribute of the IoT device; and
acquiring an ordered tree topology by sorting asset nodes in a same hierarchy in the tree topology.

9. The server according to claim 8, wherein acquiring the ordered tree topology by sorting the asset nodes in the same hierarchy in the tree topology comprises:
acquiring the ordered tree topology by sorting the asset nodes in the same hierarchy based on an order of locations of the IoT devices; or
acquiring the ordered tree topology by sorting the asset nodes in the same hierarchy based on an order of importance of the IoT devices.

10. The server according to claim 8, wherein a sequence number difference between adjacent asset nodes is a fixed value A, A being an integer greater than one; and
the method further comprises:
receiving a node insert instruction, wherein the node insert instruction is intended to indicate that T₁ asset nodes are inserted between an M₁^{th} asset node and an (M₁+1)^{th} asset node of an N₁^{th} layer of the tree topology; and
assigning sequence numbers to the inserted T₁ asset nodes based on a difference between a sequence number of the M₁^{th} asset node and a sequence number of the (M₁+1)^{th} asset node.

11. The server according to claim 10, wherein assigning the sequence numbers to the inserted T₁ asset nodes based on the difference between the sequence number of the M₁^{th} asset node and the sequence number of the (M₁+1)^{th} asset node comprises:
when the difference between the sequence number of the M₁^{th} asset node and the sequence number of the (M₁+1)^{th} asset node is greater than T₁, assigning sequence numbers to the inserted T₁ asset nodes by using sequence numbers between the sequence number of the M₁^{th} asset node and the sequence number of the (M₁+1)^{th} asset node.

12. The server according to claim 11, wherein assigning the sequence numbers to the inserted T₁ asset nodes based on the difference between the sequence number of the M₁^{th} asset node and the sequence number of the (M₁+1)^{th} asset node comprises:
when the difference between the sequence number of the M₁^{th} asset node and the sequence number of the (M₁+1)^{th} asset node is less than T₁, calculating a difference between the sequence number of the M₁^{th} asset node and a sequence number of an (M₁+1)^{th} asset node until the difference between the sequence number of the M₁^{th} asset node and the sequence number of the (M₁+1)^{th} asset node is greater than T₁+i−1;
inserting the T₁ asset nodes between the M₁^{th} asset node and the (M₁+1)^{h} asset node; and
adjusting the sequence numbers of the (M₁+1)^{th} asset node to an (M₁+i−1)^{th} asset node by using sequence numbers between the sequence number of the M₁^{th} asset node and the sequence number of the (M₁+1)^{th} asset node and assigning sequence numbers to the inserted T₁ asset nodes;
where i is an integer greater than one.

13. The server according to claim 8, wherein a sequence number difference between adjacent asset nodes is a fixed value A, A being an integer greater than one; and
the method further comprises:
receiving a node delete instruction, wherein the node delete instruction is intended to indicate that T₂ asset nodes are deleted from an N₂^{th} layer of the tree topology; and
deleting the T₂ asset nodes of the N₂^{th} layer, and eliminating sequence numbers of the T₂ asset nodes:
or
the method further comprises:
receiving a node move instruction, wherein the node move instruction is intended to indicate that T₃ asset nodes of an N₃^{th} layer are moved into between an M₃^{th} asset data node and an (M₃+1)^{th} asset data node of the N₃^{th} layer;
deleting the T₃ asset nodes of the Nth layer, and eliminating sequence numbers of the T₃ asset nodes; and
assigning sequence numbers to the inserted T₃ asset nodes based on a difference between a sequence number of the M₃^{th} asset node and a sequence number of the (M₃+1)^{th} asset ode.

14. A computer-readable storage medium storing at least one executable instruction therein;
wherein the at least one executable instruction, when loaded and executed by a processor, causes the processor to perform a method comprising:
acquiring device information and logic information of the IoT device, wherein the logic information is intended to indicate a logical attribute of the IoT device;
generating a tree topology based on the device information and the logic information of the IoT device, wherein the tree topology comprises at least two layers of asset nodes, leaf nodes of the at least two layers of asset nodes being device asset nodes, non-leaf nodes being the device asset nodes or logical asset nodes, the device asset node corresponding to the IoT device, and the logical asset node corresponding to the logical attribute of the IoT device; and
acquiring an ordered tree topology by sorting asset nodes in a same hierarchy in the tree topology.

15. The computer-readable storage medium according to claim 14, wherein acquiring the ordered tree topology by sorting the asset nodes in the same hierarchy in the tree topology comprises:
acquiring the ordered tree topology by sorting the asset nodes in the same hierarchy based on an order of locations of the IoT devices; or
acquiring the ordered tree topology by sorting the asset nodes in the same hierarchy based on an order of importance of the IoT devices.

16. The computer-readable storage medium according to claim 14, wherein a sequence number difference between adjacent asset nodes is a fixed value A, A being an integer greater than one; and
the method further comprises:
receiving a node insert instruction, wherein the node insert instruction is intended to indicate that T₁ asset nodes are inserted between an M₁^{th} asset node and an (M₁+1)^{th} asset node of an N₁^{th} layer of the tree topology; and
assigning sequence numbers to the inserted T₁ asset nodes based on a difference between a sequence number of the M₁^{th} asset node and a sequence number of the (M₁+1)^{th} asset node.

17. The computer-readable storage medium according to claim 16, wherein assigning the sequence numbers to the inserted T₁ asset nodes based on the difference between the sequence number of the M₁^{th} asset node and the sequence number of the (M₁+1)^{th} asset node comprises:
when the difference between the sequence number of the M₁^{th} asset node and the sequence number of the (M₁+1)^{th} asset node is greater than T₁, assigning sequence numbers to the inserted T₁ asset nodes by using sequence numbers between the sequence number of the M₁^{th} asset node and the sequence number of the (M₁+1)^{th} asset node.

18. The computer-readable storage medium according to claim 17, wherein assigning the sequence numbers to the inserted T₁ asset nodes based on the difference between the sequence number of the M₁^{th} asset node and the sequence number of the (M₁+1)^{th} asset node comprises:
when the difference between the sequence number of the M₁^{th} asset node and the sequence number of the (M₁+1)^{th} asset node is less than T₁, calculating a difference between the sequence number of the M1^{th} asset node and a sequence number of an (M₁+1)^{th} asset node until the difference between the sequence number of the M₁^{th} asset node and the sequence number of the (M₁+1)^{th} asset node is greater than T₁+i−1;
inserting the T₁ asset nodes between the M₁^{th} asset node and the (M₁+1)^{th} asset node; and
adjusting the sequence numbers of the (M₁+1)^{th} asset node to an (M₁+i−1)^{th} asset node by using sequence numbers between the sequence number of the M₁^{th} asset node and the sequence number of the (M₁+1)^{th} asset node and assigning sequence numbers to the inserted T₁ asset nodes;
where i is an integer greater than one.

19. The computer-readable storage medium according to claim 14, wherein a sequence number difference between adjacent asset nodes is a fixed value A, A being an integer greater than one; and
the method further comprises:
receiving a node delete instruction, wherein the node delete instruction is intended to indicate that T₂ asset nodes are deleted from an N₂^{th} layer of the tree topology; and
deleting the T₂ asset nodes of the N₂^{th} layer, and eliminating sequence numbers of the T₂ asset nodes;
or
the method further comprises:
receiving a node move instruction, wherein the node move instruction is intended to indicate that T₃ asset nodes of an N₃^{th} layer are moved into between an M₁^{th} asset data node and an (M₃+1)^{th} asset data node of the N3^{th} layer;
deleting the T₃ asset nodes of the N₃^{th} layer, and eliminating sequence numbers of the T₃ asset nodes; and
assigning sequence numbers to the inserted T₃ asset nodes based on a difference between a sequence number of the M₃^{th} asset node and a sequence number of the (M₃+1)^{th} asset node.
